(19) United States
(12) Patent Application Publication
(10) Pub. No.: US 2006/0042711 A1
(43) Pub. Date: Mar. 2, 2006

(54) Composite hose with a corrugated metal tube

(76) Inventors: Motoshige Hibino, Komaki-shi (JP); Ayumu Ikemoto, Komaki-shi (JP)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 11/214,411

(22) Filed: Aug. 29, 2005

(30) Foreign Application Priority Data
Aug. 30, 2004 (JP) 2004-250405

(51) Int. Cl. F16L 11/00

(52) U.S. Cl. 138/121; 138/127; 138/139

(57) ABSTRACT

A composite hose with a corrugated metal tube has a corrugated metal tube as a barrier layer against permeation of conveyed fluid, an elastic filler that penetrates in each valley gap on an outer peripheral side of the corrugated metal tube, between corrugation hills of the corrugated metal tube, and a reinforcing layer on an outer peripheral side of the elastic filler. The elastic filler to be adapted has a storage modulus in a range of 5×10⁸ MPa to 5×10⁹ MPa under temperature conditions ranging from −30° C. to 150° C.

### BACKGROUND OF THE INVENTION

The present invention relates to a composite hose with a corrugated metal tube as a barrier layer against permeation of conveyed fluid, which is preferably usable for conveying fuel in automobiles, conveying refrigerant, conveying fuel of cell such as hydrogen gas used in a fuel cell or other applications.

Typical rubber hoses, for example, made of a blend of acrylonitrile-butadiene rubber and polyvinyl chloride (NBR/PVC blend) which is excellent in resistance to gasoline permeability, have been used for conveying fuel (fuel such as gasoline for engine) for automobiles or the like in view of their high vibration-absorbability, easy assembling or the like. However, for the purpose of global environment protection, the regulations have been recently tighten against permeation of fuel for automobiles or the like, and are anticipated to be further tighten in the future.

Therefore, such hoses for conveying fuel are required further permeation resistance to fuel.

And, hoses for conveying fuel such as hydrogen gas used in fuel cells, or for conveying carbon dioxide gas refrigerant are required extremely high permeation resistance to such conveyed fluid as hydrogen gas and carbon dioxide gas.

However, with regard to this requirement, hoses configured by organic materials only such as rubber or resin are difficult to satisfy such required resistance.

Under the circumstances, it is considered to use a composite hose that is combined with a corrugated metal tube as a barrier layer against permeation of conveyed fluid.

Meanwhile, in the composite hose with a corrugated metal tube of such type, it is required to form the corrugated metal tube with an extremely thin-wall thickness (for example, a wall thickness equal to or smaller than 0.3 mm) for the purpose of securing flexibility or pliability. On the other hand, if the corrugated metal tube is formed with a thin-wall thickness, it becomes difficult to secure a sufficient pressure resistance when an internal pressure is exerted to the composite hose with a corrugated metal tube, specifically to the corrugated metal tube.

Then, it is effective to provide a reinforcing layer by arranging a reinforcing wire member or filament member, such as braiding or spirally winding the reinforcing wire member or filament member, on an outer peripheral side of the corrugated metal tube.

Such reinforcing layer bears an internal pressure that is exerted to the composite hose with a corrugated metal tube and thereby can provide a pressure resistance with the composite hose with a corrugated metal tube.

The composite hose with a corrugated metal tube thus including the reinforcing layer on an outer peripheral side of the corrugated metal tube is disclosed, for example, in the Patent Document No. 1 below.

By the way, such reinforcing layer that is provided in the composite hose with a corrugated metal tube can provide an effect of restraining deformation of the corrugated metal tube in radial direction, further in a longitudinal direction due to an action of an internal pressure. However, the reinforcing layer cannot provide a restraining or reinforcing effect to a side portion or intermediate side portion between a corrugation hill and a corrugation valley of the corrugated metal tube, and thereby a stress is concentrated on the side portion. So, there is a problem that the corrugated metal tube is liable to crack or break on the side portion thereof due to an action of repeated internal pressures.

[Patent Document No. 1] JP, A, 2004-52811

Under the circumstances described above, it is an object of the present invention to provide a novel composite hose with a corrugated metal tube that has an excellent fatigue endurance or fatigue durability. The composite hose with a corrugated metal tube of the present invention can solve, for example, such problem that a stress is concentrated on a side portion or intermediate side portion between a corrugation hill and a corrugation valley of the corrugated metal tube resulting in fatigue crack initiation on the side portion thereof.

### SUMMARY OF THE INVENTION

According to the present invention, there is provided a novel composite hose with a corrugated metal tube, which comprises (a) a corrugated metal tube as a barrier layer against permeation of conveyed fluid, (b) an elastic filler that penetrates in or is filled in each valley gap on an outer peripheral side of the corrugated metal tube, between corrugation hills of the corrugated metal tube, and (c) a reinforcing layer that is formed by braiding or spirally winding a reinforcing wire member or filament member on an outer peripheral side of the elastic filler. The elastic filler or the elastic filler to be adapted has a storage modulus or storage elastic modulus in a range of 5×10⁸ MPa to 5×10⁹ Mpa under temperature conditions ranging from −30° C. to 150° C., namely the temperature conditions of the whole range from −30° C. to 150° C.

In one aspect of the present invention, the elastic filler or the elastic filler to be adapted may have the storage modulus or storage elastic modulus in a range of 1×10⁹ Mpa to 5×10⁹ MPa under the temperature conditions ranging from −30° C. to 150° C., namely the temperature conditions of the whole range from −30° C. to 150° C.

The elastic filler may be made of ethylene-propylene-rubber (EPM), ethylene-propylene-diene-rubber (EPDM), styrene-butadiene rubber (SBR) or silicon rubber.

In one aspect of the present invention, a wall thickness of the elastic filler is designed 0.3 mm or less at position of tops of the corrugation hills of the corrugated metal tube

As stated above, in the composite hose with a corrugated metal tube according to the present invention, the elastic filler penetrates in each valley gap on an outer peripheral side of the corrugated metal tube, between the corrugation hills thereof. The elastic filler to be adapted has a storage modulus in a range of 5×10⁸ MPa to 5×10⁹ MPa under temperature conditions ranging from −30° C. to 150° C.

Here, the term “storage modulus” or “storage elastic modulus” is a measure or size of energy that is stored and recovered per a load cycle, namely strength of a force or a force of the elastic filler attempting to return to its original shape after the deforming force (load) is removed.

The side portion of the corrugated metal tube tends to be deformed in an expanding manner toward the valley gap or into the valley gap under an action of an internal pressure, specifically, under the internal pressure exerted to the side portion. The elastic filler, which penetrates in the valley gap on an outer peripheral side of the corrugated metal tube, between the corrugation hills thereof, serves to push back the side portion on a side of the valley gap to prevent that the side portion is deformed in an expanding manner toward the valley gap resulting in a stress concentration on the side portion.

The inventors focused on characteristics of the elastic filler penetrating in the valley gap during the study about a fatigue crack of the corrugated metal tube caused by stress concentration on the side portion. Then, the inventors detected that fatigue strength, namely endurance or durability of the corrugated metal tube against crack on the side portion varies by changing storage modulus of the elastic filler.

Specifically, the inventors detected that when the elastic filler penetrating in the valley gap has a high storage modulus, or an elastic material with high storage modulus is adapted for the elastic filler penetrating in the valley gap, durability of the corrugated metal tube against crack on the side portion can be effectively enhanced.

However, when the storage modulus of the elastic filler is increased, the durability against an action of repeated internal pressures is improved, but on the other hand flexibility required for a hose is lowered.

The composite hose with a corrugated metal tube adapted for convening a fluid requires favorable or good flexibility and bending property as well as durability. So, the inventors studied the storage modulus of the elastic filler that can satisfy both of these properties, and reached the conclusion that the elastic filler to be adapted preferably has or needs to have a storage modulus in a range of 5×10⁸ MPa to 5×10⁹ MPa under temperature conditions ranging from −30° C. to 150° C. Namely, both properties of flexibility and durability required for the composite hose with a corrugated metal tube can be satisfied by adapting the elastic filler with the storage modulus in this range.

The present invention is made based on these studies.

According to the present invention, it may be effectively prevented that a stress is concentrated on the side portion between the corrugation hill and the corrugation valley and thereby a crack is caused on the side portion. Accordingly, it becomes possible to provide the composite hose with a corrugated metal tube with favorable or good durability. Also, according to the present invention, it becomes possible to secure flexibility practically required for the composite hose with a corrugated metal tube.

More preferably, the elastic filler to be adapted has the storage modulus of 1×10⁹ MPa or above under the temperature conditions ranging from −30° C. to 150° C.

In order to provide the elastic filler with the storage modulus as above, it is preferred to apply EPM, EPDM, SBR or silicon rubber for the elastic filler.

When a wall thickness of the elastic filler is designed 0.3 mm or less at position of tops of the corrugation hills of the corrugated metal tube, restraining or reinforcing effect by the reinforcing layer promptly acts on the corrugated metal tube when an internal pressure is exerted thereto, and thereby durability of the composite hose with a corrugated metal tube can be further improved.

Now, the preferred embodiments of the present invention will be described in detail with reference to the drawings.

### BRIEF DESCRIPTION OF THE DRAWINGS

FIG. 1 (A) is a sectional view of a composite hose with a corrugated metal tube according to one embodiment of the present invention.

FIG. 1 (B) is an enlarged sectional view of an end portion of the composite hose with a corrugated metal tube of FIG. 1 (A).

FIG. 2 (A) is an enlarged sectional view showing a hose body of the composite hose with a corrugated metal tube of FIG. 1 (A).

FIG. 2 (B) is an enlarged sectional view showing a corrugated portion of a corrugated metal tube of FIG. 2 (A).

FIG. 3 (A) is a view showing a corrugated portion where an elastic filler is not filled.

FIG. 3 (B) is an explanatory view showing deformation mode of the corrugated portion of FIG. 3 (A) under internal pressure.

FIG. 4 is a chart showing change of storage modulus of IIR at different temperatures.

FIG. 5 is a chart showing change of storage modulus of various elastic materials at different temperatures.

FIG. 6 is a chart showing change of storage modulus of other various elastic materials at different temperatures.

FIG. 7 (A) is an explanatory view showing method for evaluating pliability of a hose.

FIG. 7 (B) is an explanatory view showing method for evaluating durability of a hose against repeated pressures.

### DETAILED DESCRIPTIONS OF PREFERRED EMBODIMENTS

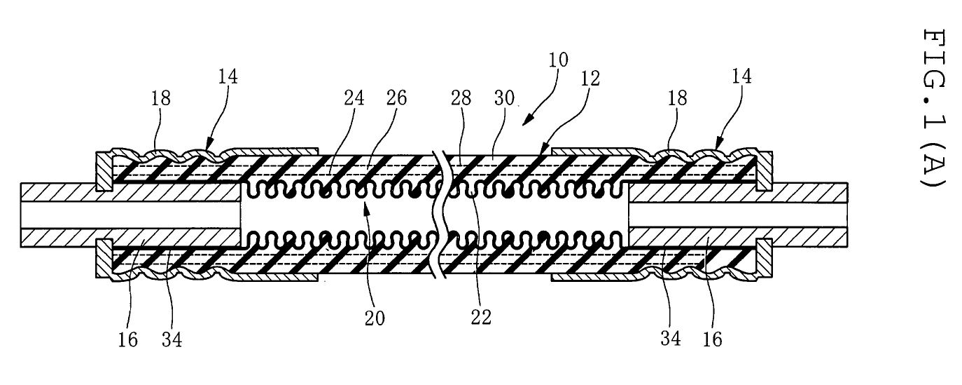

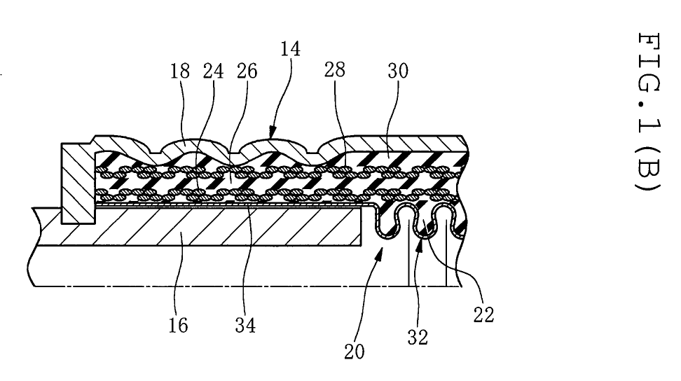

In FIG. 1(A), reference numeral 10 indicates a composite hose with a corrugated metal tube (herein after just referred as a hose), reference numeral 12 indicates a hose body, and reference numeral 14 indicates a joint fitting that is attached on an end portion of the hose body 12.

A joint fitting 14 has a pipe shaped insert fitting 16 and a sleeve like socket fitting 18. The joint fitting 14, namely the socket fitting 18 and the insert fitting 16 are securely fixed to the end portion of the hose body 12 by securely swaging the socket fitting 18 on the end portion of the hose body 12 in a diametrically contracting direction.

The hose 10 has a corrugated metal tube 20 as an innermost layer. An outer peripheral side of the corrugated metal tube 20 is covered or laminated in sequence with an elastic filler (preferably a rubber filler) 22, a reinforcing layer 24, a middle rubber layer 26, another reinforcing layer 28 and an outer surface rubber layer (cover rubber layer) 30 as an outermost layer.

As shown in FIG. 1 (B), the corrugated metal tube 20 has a corrugated portion 32 and a straight-wall portion or straight-walled portion 34 of straight tubular shape on an end portion thereof. The above inert fitting 16 is inserted and fitted inside the straight-walled portion 34.

The corrugated metal tube 20 as an innermost layer serves as a barrier layer against permeation of conveyed fluid, and is given flexibility by the corrugated portion 32.

On the other hand, the reinforcing layers 24, 28 are provided for securing pressure resistance. Here, the reinforcing layers 24, 28 are formed by braiding or spirally winding a reinforcing wire member such as reinforcing yarn.

In this instance, the reinforcing layers 24, 28 serve to restrain the hose 10 from expanding in a radial direction and from being deformed in a longitudinal direction when an internal pressure is exerted by the conveyed fluid flowing inside the hose 10.

The middle rubber layer 26 between these reinforcing layers 24, 28 serves to restrain the reinforcing layers 24, 28 from being displaced with respect to one another, and being worn out, and to unify these layers 24, 28.

The outer surface rubber layer 30 as outermost layer serves to protect the reinforcing layer 28.

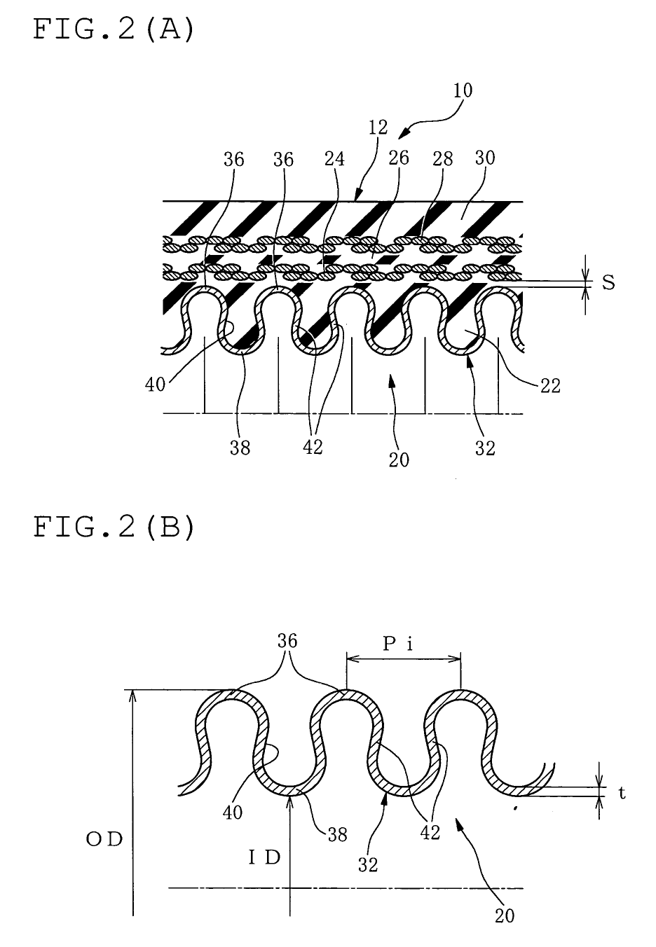

The elastic filler (made of nonfoamed material) 22 penetrates in gaps or valley gaps 40 between adjacent corrugation hills 36, 36 of the corrugated portion 32 on an outer peripheral side thereof as shown in FIG. 2 (A) in order to restrain each side portion or intermediate side portion 42 between the corrugation hill 36 and a corrugation valley 38 from being deformed toward the valley gap 40 in an expanding manner when an internal pressure is exerted to the corrugated portion 32.

In FIG. 2 (B), OD indicates an outer diameter of the corrugated metal tube 20 (the corrugated portion 32 or the corrugation hill 36), ID indicates an inner diameter thereof (the corrugated portion 32 or the corrugation valley 38), and Pi indicates a corrugation pitch and t indicates a wall-thickness of the corrugated metal tube 20, respectively.

In this embodiment, the elastic filler 22 is filled completely in the valley gaps 40 at least to tops of the corrugation hills 36. However, a radial thickness or a wall thickness S of the elastic filler 22 measured between the tops of the corrugation hills 36 of the corrugated portion 32 and the reinforcing layer 24 is designed 0.3 mm or less.

In this embodiment, the corrugated metal tube 20 preferably has a wall thickness t of 0.5 mm or less, specifically 0.3 mm or less in view of elasticity or flexibility required.

On the other hand, in view of workability or processability of a metal tube, the corrugated metal tube 20 preferably has the wall thickness t of 0.1 mm or larger.

And, as for material of the corrugated metal tube 20, iron, iron steel, stainless steel or other alloy steel, aluminum or aluminum alloy, copper or copper alloy, nickel or nickel alloy, titanium or titanium alloy, tin or tin alloy, or the like may be used. The material of the corrugated metal tube 20 may be selected properly from these materials in view of resistance to conveyed fluid, durability against vibration/pressure, workability of a metal tube, or the like. Specifically, stainless steel is preferably used.

As for material or raw material for reinforcing wire members or filament members of the reinforcing layers 24, 28, usable are various materials. For example, as for the reinforcing wire members or filament members of the reinforcing layers 24, 28, usable are reinforcing threads formed from organic fiber. According to need, a metal wire may be used.

And, for the elastic filler or the elastic filler layer 22, any elastic materials other than rubber, for example, such as thermoplastic elastomer may be also used.

As stated above, the rubber filler or the elastic filler 22 serves to restrain the side portion 42 between the corrugation hill 36 and the corrugation valley 38 in the corrugated metal tube 20 from being deformed in an expanding manner toward the valley gap 40 when an internal pressure is exerted to the corrugated portion 32.

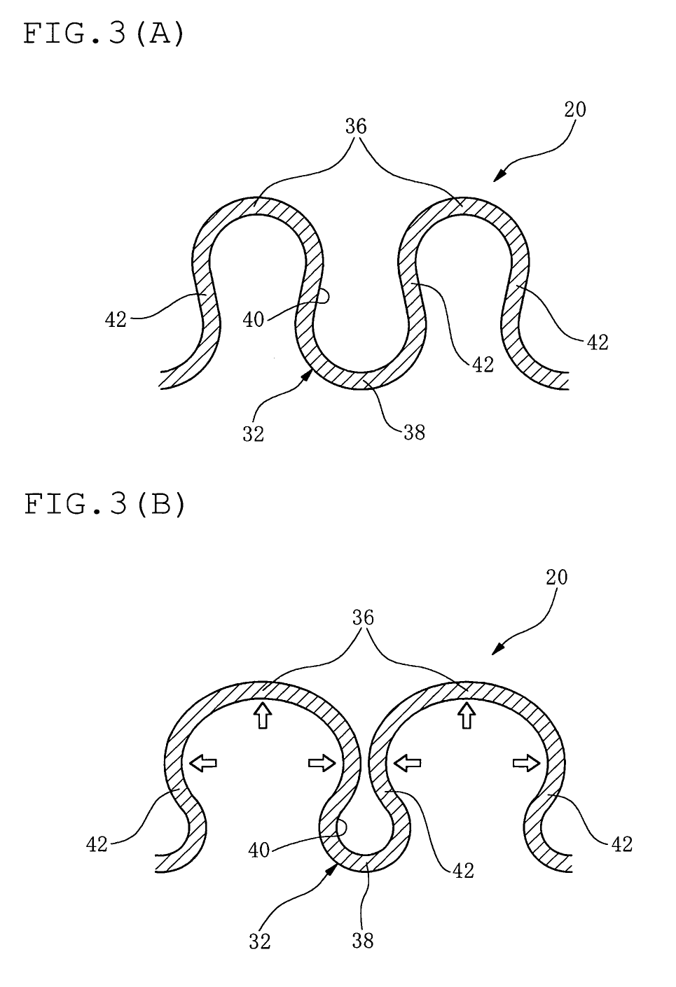

Namely, as shown in FIG. 3 (A), if the valley gap 40 is not filled with the elastic filler layer 22 and remains hollow, the side portion 42 is easily deformed in an expanding manner toward the hollow portion, namely the valley gap 40, when an internal pressure is exerted to the corrugated metal tube 20 as shown in FIG. 3 (B). As a result, durability of the corrugated metal tube 20 is largely deteriorated.

On the contrary, deformation of the corrugated metal tube 20 can be restrained when an internal pressure is exerted thereto by filling the valley gap 40 with the elastic filler 22 and thereby durability of the corrugated metal tube 20 can be effectively enhanced.

The elastic filler 22 makes an effect as above. However, if the elastic filler 22 has a low storage modules, namely the elastic filler 22 has a small force to restore its original shape, or a low elasticity or elastic force in a restoring direction after deformation, a force for pushing back the side portion 42 of the corrugated metal tube 20 that attempts to be deformed by an action of the internal pressure is lowered. Resultantly, as the case may be, the elastic filler 22 cannot make an effect sufficiently.

So, in view of improvement of durability against an action of repeated internal pressures, it is preferred to apply the elastic filler 22 that has storage modulus as high as possible.

On the other hand, the higher storage modulus the elastic filler 22 has, the lower flexibility the hose 10 has.

In order to increase a degree of freedom of piping design, or to provide a vibration isolation or vibration shutoff in an automobile or the like, the hose 10 preferably has pliability and flexibility as much as possible.

In this point of view, the elastic filler 22 has a storage modulus or storage elastic modulus within a range of 5×10⁸ to 5×10⁹ MPa under temperature conditions ranging from −30° C. to 150° C., namely under the temperature conditions of the whole range from −30° C. to 150° C.

The storage modulus of the elastic filler 22 in this range can provide the hose 10 with both favorable durability and favorable flexibility.

[Test Sample]

1. Production of a test sample (specimen) with respective to the hose 10

The test sample is produced in a following manner.

A corrugated metal tube 20 is formed from SUS304 material.

Here, the corrugated metal tube 20 has a following shape, namely, an outer diameter (OD) of 9.7 mm, an inner diameter (ID) of 4.5 mm, a wall-thickness (t) of 0.23 mm, corrugation pitch (Pi) of 2.0 mm. In the corrugated metal tube 20, the corrugated portion 32 has an overall length of 400 mm, and straight-walled tubular portions 34 are provided on both ends thereof. Each of the straight-walled tubular portions 34 has a length of 30.0 mm, and the same outer diameter as the corrugated portion 32.

Then, a layer of unvulcanized isobutene-isoprene rubber (butyl rubber, IIR) is formed or molded as an elastic filler on an outer side of the corrugated metal tube 20. And, further, one and the other reinforcing layers 24, 28 are formed by braiding aramid threads on an outer side thereof with interposing a middle rubber layer 26 between the one and the other reinforcing layers 24, 28.

Then, the outer surface rubber layer 30 is laminated or overlaid on an outer peripheral side of the other reinforcing layer 28 to obtain an unvulcanized hose body. And, the unvulcanized hose body is heated under the condition of 150° C. for 45 minutes to vulcanize a rubber of the hose body.

After that, a joint fitting 14, namely an insert fitting 16 and a socket fitting 18 are attached to each of opposite end portions of the hose body, and thereby the test sample with respect to the hose 10 is obtained.

The elastic filler is filled in so as to have a radial thickness S of about 0.2 mm between tops of the corrugation hills 36 of the corrugated metal tube 20 and the one reinforcing layer 24.

2. Evaluation of Pliability (Evaluation of Flexibility)

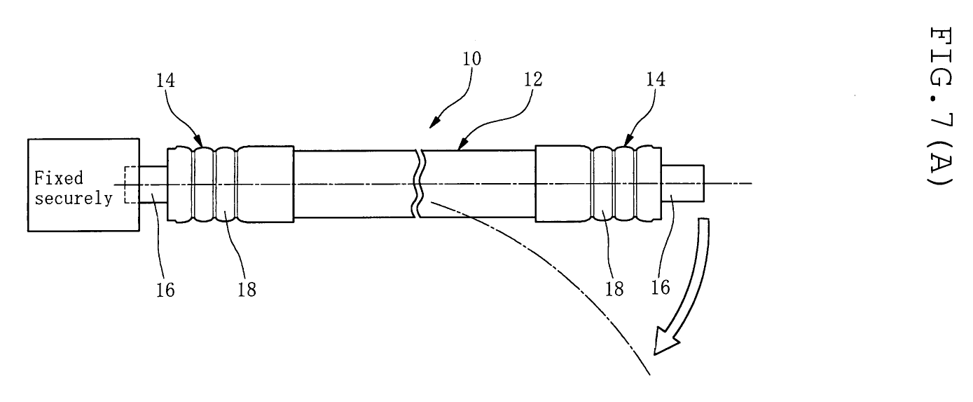

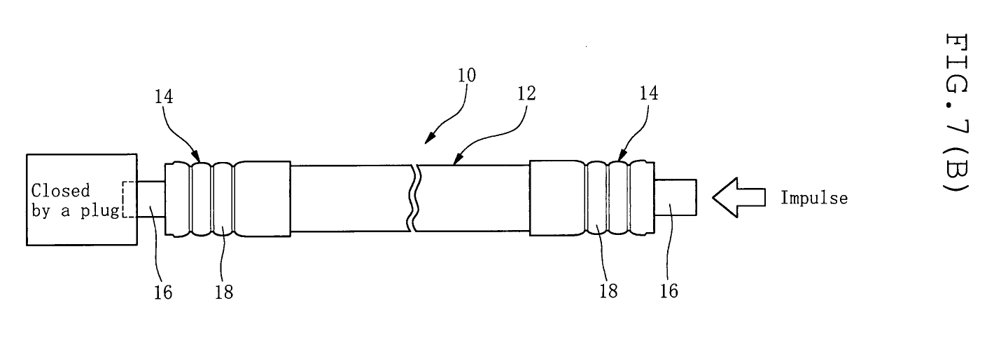

As shown in FIG. 7 (A), the test sample with respect to the hose 10 is securely fixed on one end, is bent by exerting a force on the other end until its bent radius R reaches 60 mm, and a strength value (torque) at that time is measured. When a strength value is up to 3 (N·m), pliability is judged good or favorable and a circle is given in a corresponding column of Table 1. When a strength value exceeds 3 (N·m), pliability is judged inferior and a cross is given in a corresponding column of Table 1.

Since rubber hardness is increased and pliability is deteriorated as temperature lowers, an evaluation is made with respect to the test sample in temperature atmosphere from −30° C. to 16° C.

TABLE 1

| | Storage | | Evaluation of | |
|---|---|---|---|---|
| Temperature | modulus | | pliability | Judge- |
| (° C.) | (MPa) | Impulse test (cycles) | (N · m) | ment |
| −30 | 8.41 × 10⁹ | 294561, 280012, | 5.1 . . . cross | Cross |
| | | 303341 . . . double | | |
| | | circle | | |
| −26 | 5.76 × 10⁹ | 189326, 219784, | 4.2 . . . cross | Cross |
| | | 179425 . . . double | | |
| | | circle | | |
| −24 | 4.91 × 10⁹ | 162537, 141899, | 2.9 . . . circle | Circle |
| | | 124733 . . . double | | |
| | | circle | | |
| −6 | 1.02 × 10⁹ | 112248, 100357, | 2.5 . . . circle | Circle |
| | | 123005 . . . double | | |
| | | circle | | |
| 6 | 5.88 × 10⁸ | 26055, 19172, | 2.3 . . . circle | Circle |
| | | 35388 . . . circle | | |
| 10 | 4.91 × 10⁸ | 9862, 8635, | 2.2 . . . circle | Cross |
| | | 9524 . . . cross | | |
| 16 | 4.11 × 10⁸ | 7945, 8812, | 2.1 . . . circle | Cross |
| | | 6937 . . . cross | | |

3. Evaluation of Durability

As shown in FIG. 7 (B), the test sample with respect to the hose 10 is held straight, closed by a plug on one end thereof, connected to hydraulic equipment on the other end thereof, and durability is evaluated by supplying repeatedly silicon oil therein.

Here, the silicon oil is supplied at repetition pressure of 20 MPa and pressure cycle (impulse rate) of 50 cpm.

This impulse test (repeated pressurizing test) is conducted in various temperature atmospheres.

The results of the evaluation of pliability and evaluation of durability under impulse (repeated pressures) are shown in Table 1. With regard to the durability (impulse test), double-circle indicates superior, a circle indicates good, and a cross indicates inferior.

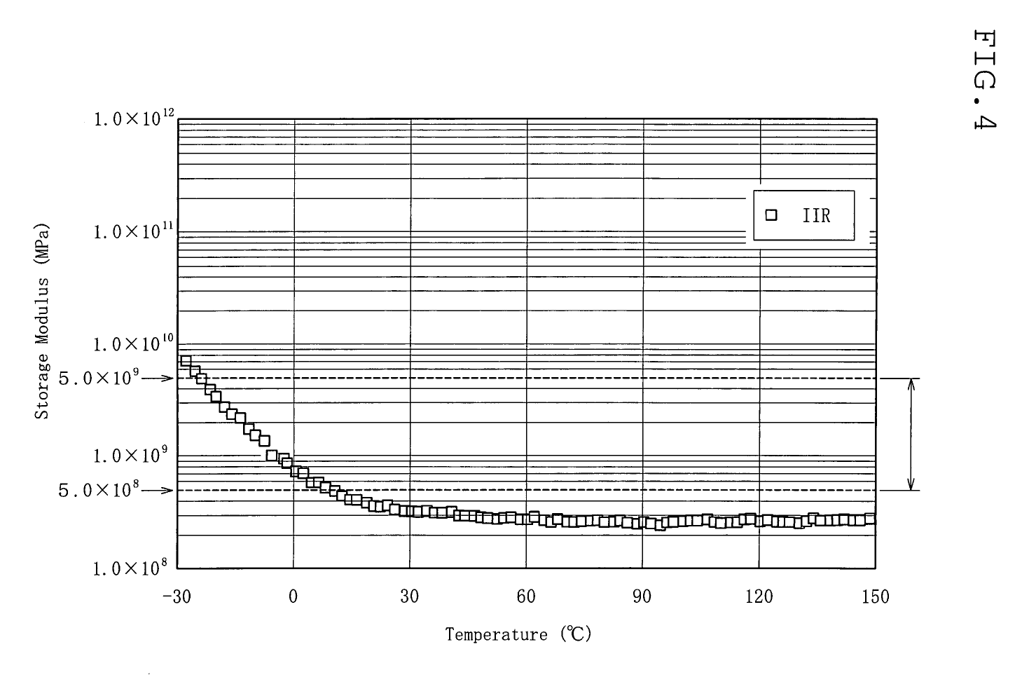

And, storage modulus of IIR at various of temperatures is shown also in FIG. 4.

In the evaluation of durability under impulse test (repeated pressurizing test), when storage modulus of the elastic filler is 5×10⁸ MPa or above, the number of durable cycles is 10,000 or more, namely a target value of 10,000 cycles can be achieved. Specifically, when storage modulus thereof is 1×10⁹ MPa or above, the number of durable cycles over 100,000 can be obtained.

On the other hand, as for pliability, when storage modulus thereof is up to 5×10⁹ MPa, a target value of pliability is satisfied.

As a conclusion, when storage modulus of the elastic filler is in a range of 5×10⁸ MPa to 5×10⁹ MPa, both properties, namely durability under impulse (repeated pressures) and pliability can be satisfied (in the column of “judgment” of Table 1, when the both properties are satisfied, a circle is given, and when at least one of the both properties is not satisfied, a cross is given).

4. Storage Modulus of Various Materials

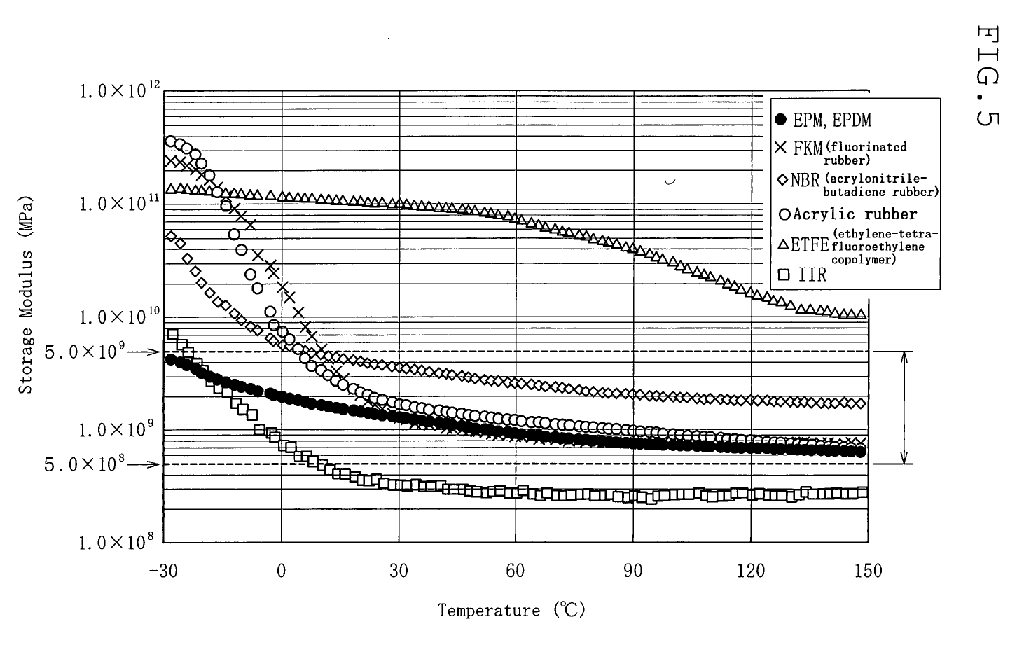

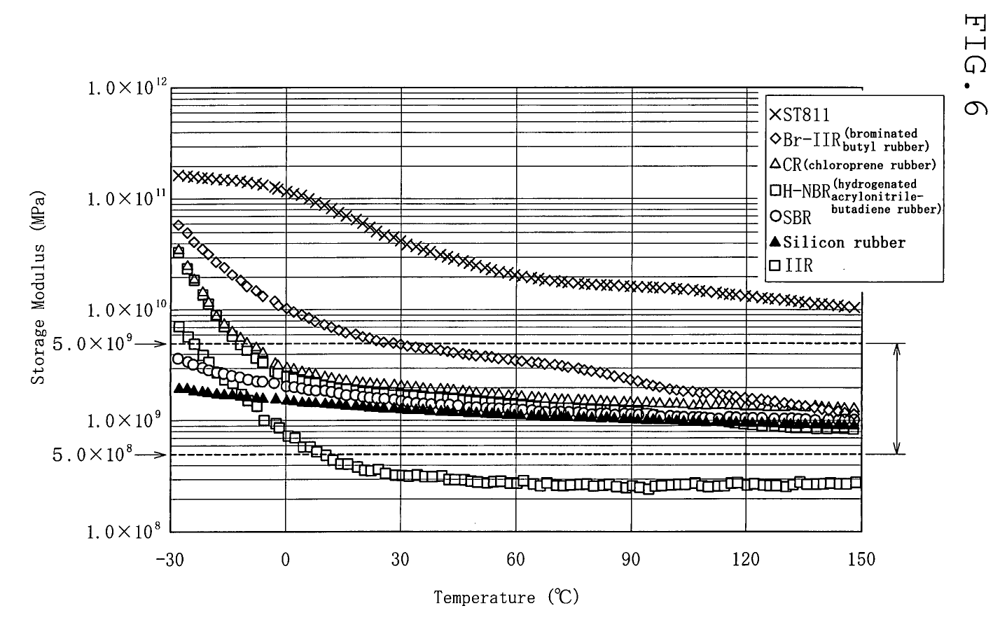

Next, in order to examine eligibility of material for the elastic filler 22, storage modulus values are found under temperature conditions ranging from −30° C. to 150° C. with respect to various elastic materials in FIGS. 5 and 6, and the results are shown in FIGS. 5 and 6. A material “ST811” in FIG. 6 is a modified polyamide, which is an alloy of polyamide-6 and maleic anhydride modified polyolefin, and sold by Dupont under a trade name of Zytel (trademark) ST series.

In FIGS. 5 and 6, materials that meet the target storage modulus of 5×10⁸ MPa to 5×10⁹ MPa under the temperature conditions of the whole range from −30° C. to 150° C. are EPM, EPDM, SBR and silicon rubber. So, it can be understood that EPM, EPDM, SBR and silicon rubber are suitable for materials of the elastic filler 22.

Although the preferred embodiments have been described above, these are only some of embodiments of the present invention.

The present invention may be constructed and embodied in various configurations and modes within the scope of the present invention.

What is claimed is:

1. A composite hose with a corrugated metal tube, comprising:
(a) a corrugated metal tube as a barrier layer against permeation of conveyed fluid,
(b) an elastic filler penetrating in each valley gap on an outer peripheral side of the corrugated metal tube, between corrugation hills of the corrugated metal tube,
(c) a reinforcing layer formed by braiding or spirally winding a reinforcing wire member on an outer peripheral side of the elastic filler, and
the elastic filler to be adapted having a storage modulus in a range of 5×10⁸ MPa to 5×10⁹ MPa under temperature conditions ranging from −30° C. to 150° C.

2. The composite hose as set forth in claim 1, wherein the elastic filler to be adapted has the storage modulus of 1×10⁹ MPa or above under the temperature conditions ranging from −30° C. to 150° C.

3. The composite hose as set forth in claim 1, wherein the elastic filler is made of EPM, EPDM, SBR or silicon rubber.

4. The composite hose as set forth in claim 1, wherein a wall thickness of the elastic filler is designed 0.3 mm or less at position of tops of the corrugation hills of the corrugated metal tube.
